(19) United States
(12) Patent Application Publication
(10) Pub. No.: US 2026/0319534 A1
(43) Pub. Date: Oct. 15, 2026

(54) DIGITAL LOW-DROPOUT (DLDO) REGULATOR WITH ERROR-SUBTRACTING COUNTER FOR IMPROVED STABILITY AND POWER SUPPLY REJECTION

(71) Applicant: Georgia Tech Research Corporation, Atlanta, GA (US)

(72) Inventor: Utsav Vasudevan, Atlanta, GA (US)

(21) Appl. No.: 19/546,870

(22) Filed: Feb. 23, 2026

Related U.S. Application Data
(60) Provisional application No. 63/788,924, filed on Apr. 15, 2025.

(51) Int. Cl. G05F 1/563; G05F 1/569

(52) U.S. Cl. CPC G05F 1/563; G05F 1/569

(57) ABSTRACT

A digital low-dropout voltage regulator includes a comparator that compares a feedback voltage derived from a regulated output voltage with a reference voltage to generate a digital error signal. A primary digital counter increments or decrements a digital control word based on the digital error signal. A secondary digital counter, operating at half the clock frequency of the primary digital counter, accumulates an intermediate digital value based on the digital error signal. An exclusive-OR gate and delay elements detect a change in polarity of the digital error signal and generate a direction-change signal. Subtraction circuitry subtracts the intermediate digital value from the digital control word in response to the direction-change signal to produce a corrected digital control word. Enable logic enables the secondary digital counter when the digital control word is within an operational range. The corrected digital control word controls a pass device array to regulate the output voltage.

### CROSS-REFERENCE TO RELATED APPLICATIONS

This application claims the benefit of and priority to U.S. Provisional Application No. 63/788,924, filed Apr. 15, 2025, titled “DIGITAL LOW-DROPOUT (DLDO) REGULATOR WITH ERROR-SUBTRACTING COUNTER FOR IMPROVED STABILITY AND POWER SUPPLY REJECTION,” the entire contents of which is hereby incorporated herein by reference.

### BACKGROUND

Modern integrated circuits, particularly system-on-chip (SoC) solutions, incorporate numerous digital and analog functional blocks operating simultaneously at various voltage and power levels. Each functional block typically requires a stable and tailored voltage supply for proper functionality and to ensure operational efficiency. These diverse voltage requirements are often met using local point-of-load (PoL) regulators that convert and condition an incoming higher voltage into the lower regulated voltages needed by specific blocks within the integrated circuit.

Low-dropout (LDO) regulators are frequently used as PoL supplies because they offer advantages such as compact form factors, simplicity, low noise generation, and effective isolation from fluctuations in the primary power source. LDO regulators commonly include a pass transistor configured to deliver a regulated voltage output with minimal voltage drop across the pass transistor, thereby improving efficiency. However, conventional analog LDOs typically require large off-chip capacitors to maintain stability under varying load conditions, rendering their integration challenging for high-density applications or multi-core SoC solutions.

Digital low-dropout (DLDO) regulators have emerged to address these integration challenges, offering several advantages over traditional analog implementations. DLDO regulators generally employ digital feedback loops, incorporating analog-to-digital converters (ADC), digital-to-analog converters (DAC), and digital logic such as counters or controllers to maintain output voltage regulation. Because of their inherently digital nature, DLDO regulators can be more easily scaled and integrated into modern digital semiconductor manufacturing processes. Furthermore, DLDO designs typically eliminate the need for large external capacitors, reducing footprint, simplifying integrated circuit board layout, and improving integration density.

Despite these advantages, existing DLDO regulator implementations are subject to certain practical limitations. The digital feedback nature of DLDO regulators introduces discrete quantization effects, which often result in oscillations and ripple in the output voltage. The inherently sampled nature of digital feedback can also cause stability challenges and sub-clock oscillations under varying operating conditions and transient load changes. Moreover, conventional DLDO regulators frequently exhibit limited power supply rejection (PSR), making them susceptible to power-supply disturbances. These limitations can degrade performance, limit operating speed, and restrict the practical application of DLDO regulators in noise-sensitive and high-performance integrated circuits.

### SUMMARY

In various aspects of the present disclosure, a digital low-dropout (DLDO) voltage regulator includes a comparator configured to compare a feedback voltage derived from a regulated output voltage with a reference voltage and to generate a digital error signal. A primary digital counter is coupled to the comparator and configured to increment or decrement a digital control word based on the digital error signal. A secondary digital counter is coupled to the comparator and clocked at half a clock frequency of the primary digital counter, the secondary digital counter configured to accumulate an intermediate digital value based on the digital error signal. One or more delay elements and an exclusive-OR gate are coupled to the comparator, the exclusive-OR gate configured to generate a direction-change signal indicating a change in polarity of the digital error signal between successive clock cycles. Subtraction circuitry is configured to subtract the intermediate digital value from the digital control word to produce a corrected digital control word in response to the direction-change signal. Enable logic is configured to enable the secondary digital counter when the digital control word is greater than zero and less than a full-scale maximum value, and to disable the secondary digital counter otherwise. A pass device array including a plurality of transistor segments is configured to receive a control signal derived from the corrected digital control word and to regulate the output voltage based on the control signal.

In various aspects of the present disclosure, a method for regulating an output voltage in a DLDO voltage regulator includes comparing a feedback voltage derived from the output voltage with a reference voltage to generate a digital error signal, updating a digital control word stored in a primary digital counter by incrementing or decrementing the digital control word based on the digital error signal, accumulating an intermediate digital value in a secondary digital counter at half a clock frequency of the primary digital counter based on the digital error signal, detecting a change in polarity of the digital error signal between successive clock cycles, in response to detecting the change in polarity, subtracting the intermediate digital value from the digital control word to produce a corrected digital control word, and controlling a pass device array based on the corrected digital control word to regulate the output voltage.

In various aspects of the present disclosure, a voltage regulator circuit includes a first counter configured to store a control word and to update the control word based on a comparison between a feedback signal and a reference signal. A second counter is clocked at a fraction of a clock frequency of the first counter, the second counter configured to accumulate a correction value based on the comparison. A polarity-change detector is coupled to an output of the comparison, the polarity-change detector configured to generate a trigger signal upon detecting a change in polarity of the output of the comparison. Subtraction circuitry is configured to subtract the correction value from the control word in response to the trigger signal to produce a corrected control word for controlling an output voltage of the voltage regulator circuit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an integrated circuit power-supply architecture including multiple digital low-dropout (DLDO) regulators arranged to provide individually regulated supply voltages to different functional blocks within a System-on-Chip (SoC), according to various implementations of the present disclosure.

FIG. 2 depicts a circuit-level architecture of a DLDO regulator, according to various implementations of the present disclosure.

FIG. 3 depicts a circuit schematic of an error-subtracting counter architecture, according to various implementations of the present disclosure.

FIG. 4 depicts a method for operating a DLDO regulator that employs an error-subtracting counter circuit, according to various implementations of the present disclosure.

FIG. 5 depicts a method for fabricating and configuring an error-subtracting counter circuit, according to various implementations of the present disclosure.

FIG. 6 depicts a simulated waveform illustrating sub-clock oscillation behavior in a conventional DLDO regulator, according to various implementations of the present disclosure.

FIG. 7 depicts a simulated waveform illustrating delay cancellation by an error-subtracting counter circuit, according to various implementations of the present disclosure.

FIG. 8 depicts a simulated load dump response comparing transient performance of conventional DLDO regulators with a DLDO regulator employing an error-subtracting counter circuit, according to various implementations of the present disclosure.

FIG. 9 depicts a diagram illustrating a cause of sub-clock oscillation in a conventional DLDO regulator, according to various implementations of the present disclosure.

FIG. 10 depicts a graph illustrating simulated slew rate thresholds for power supply rejection in a DLDO regulator employing an error-subtracting counter circuit, according to various implementations of the present disclosure.

### DETAILED DESCRIPTION

The present disclosure addresses specific limitations associated with conventional digital low-dropout (DLDO) regulators, particularly issues related to stability, slow transient response, sub-clock oscillations, excessive output ripple, and poor low-frequency power supply rejection (PSR). Traditional DLDO regulators rely on digital feedback loops incorporating analog-to-digital conversion (ADC), digital counters, and digital-to-analog conversion (DAC). Although this approach improves compactness and integration density compared to analog regulators, it inherently introduces quantization errors and stability constraints. In particular, existing digital LDO designs suffer from inherent limit-cycle oscillations due to discrete feedback adjustments. Furthermore, variations in input voltage and load conditions commonly cause sub-clock oscillations, severely degrading output voltage stability and transient performance. Prior attempts to mitigate these challenges typically involved either increasing digital resolution—leading to impractically large transistor arrays and slower response times—or employing complex hybrid analog-digital solutions that increase circuit complexity, area, and power consumption.

To overcome these drawbacks, the present disclosure introduces a digital feedback mechanism employing an error-subtracting counter, enabling stable DLDO regulator operation while reducing transient response times and suppressing sub-clock oscillations. The error-subtracting counter circuit proactively adjusts the digital control word in response to output voltage deviations, effectively removing sub-clock oscillations, which have previously proven challenging to control. Unlike existing DLDO solutions, the improved digital feedback mechanism ensures stability across a broader range of input voltages and load conditions without the need for complex analog circuitry or excessively large transistor arrays.

The present disclosure provides several advantages over existing DLDO solutions, including, for example: (1) improved stability due to the elimination or substantial reduction of sub-clock oscillations; (2) faster transient response achieved without requiring high clock frequencies or larger transistor arrays; (3) reduced output ripple through the mitigation of limit-cycle oscillations; (4) enhanced PSR performance at lower frequencies, ensuring greater immunity to input voltage variations and power supply disturbances; and so on. Accordingly, the present disclosure provides a DLDO regulator design that effectively integrates digital implementation benefits with improved stability, high transient performance, and power-supply disturbance rejection.

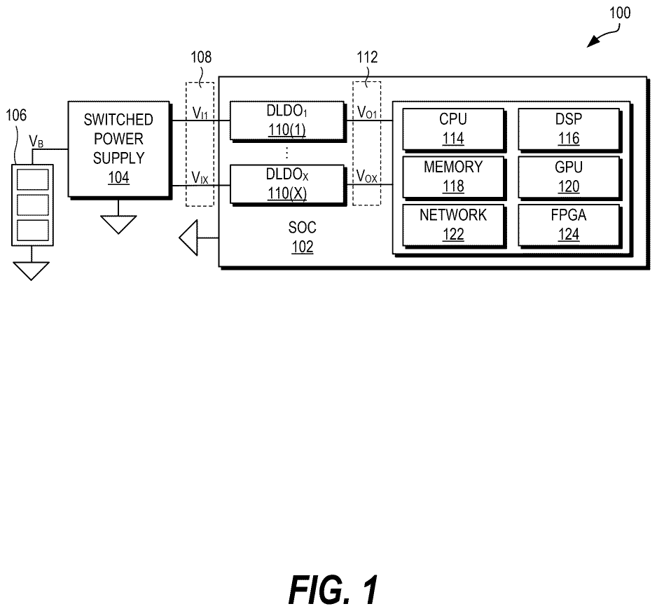

FIG. 1 depicts a system 100 in which a digital low-dropout (DLDO) regulator architecture disclosed herein may be implemented, according to various implementations. The system 100 includes a System-on-Chip (SoC) 102 receiving a primary input voltage from a switched power supply 104, such as a switched-mode power supply (SMPS). The switched power supply 104 draws energy from an energy storage device, such as a battery 106, to generate and regulate input voltages 108 (e.g., V_{I1} through V_{IX}) delivered to the SoC 102. For example, the battery 106 may be a lithium-ion or lithium-polymer battery providing nominal voltage in the range of about 3.7 V, which is subsequently converted down to lower, regulated voltages suitable for internal use by the SoC 102.

The SoC 102 integrates multiple DLDO regulators 110(1)-110(X), each serving as local point-of-load (POL) voltage regulators to provide precise, regulated output voltages 112 (V_{O1} through V_{OX}). The regulated output voltages 112 are specifically tailored for different circuit blocks within the SoC 102, providing optimized voltage levels for distinct functionality, thereby enhancing performance, efficiency, and integration. Each DLDO regulator 110 may be configured to supply voltages typically ranging from approximately 0.5 V to 1.1 V with load currents that can vary from a few milliamps to tens of milliamps, for example.

As further depicted in FIG. 1, functional blocks within the SoC 102 can include, but are not limited to, a central processing unit (CPU) 114, a digital signal processor (DSP) 116, a memory module 118, a graphics processing unit (GPU) 120, a network interface 122, and a field-programmable gate array (FPGA) 124. These blocks exemplify diverse operational components within a typical SoC, each with distinct power-supply requirements.

The CPU 114 performs general-purpose computations and logic operations, typically requiring stable, low-noise voltages to maintain computational accuracy and reliability. For example, CPUs often operate at low voltages (around 0.8-1.1 V) at varying currents depending on computational load.

The DSP 116 performs specialized digital signal processing tasks such as signal filtering, modulation/demodulation, and fast mathematical computations. A DSP might require a tightly regulated voltage (e.g., approximately 0.9-1.0 V) to ensure accurate signal processing.

The memory module 118 can be dynamic or static random-access memory (DRAM/SRAM) used for temporary data storage. For instance, embedded SRAM typically operates around 0.8-1.0 V and requires stable, low-noise supply voltages to prevent memory errors.

The GPU 120 handles intensive graphical computations and rendering tasks. GPUs typically have variable voltage requirements (0.8-1.1 V) depending on graphics workloads and performance scaling.

The network interface 122 enables data transfer and connectivity via Ethernet and/or wireless communication protocols (e.g., Wi-Fi and/or Bluetooth®). For example, network circuits typically need precise voltage levels (around 0.9-1.0 V) for reliable communication performance.

The FPGA 124 provides reconfigurable logic functionality and may be used for custom digital signal processing or logic control. FPGA cores frequently have adjustable voltage supplies (e.g., approximately 0.8-1.0 V) for power-performance optimization.

By providing individual DLDO regulators 110(1)-110(X) for each functional block, the system 100 ensures tailored power delivery, thereby optimizing power efficiency and performance while enabling dynamic voltage and frequency scaling (DVFS). Unlike conventional analog LDO regulators, DLDO regulators integrated within the SoC 102 do not typically require large external capacitors for stabilization, reducing component count and printed circuit board (PCB) complexity. Each DLDO regulator 110 can integrate digital feedback mechanisms, including at least an analog-to-digital converter (ADC), digital counters, and a digital-to-analog converter (DAC), enabling precise digital regulation and facilitating integration within digital semiconductor (e.g., Complementary Metal-Oxide-Semiconductor (CMOS)) processes.

Accordingly, the system 100 exemplifies a highly integrated, digitally controlled, multi-voltage power management architecture particularly advantageous in modern, high-performance, and densely integrated SoCs, such as those found in advanced mobile processors, data center applications, and embedded computing platforms.

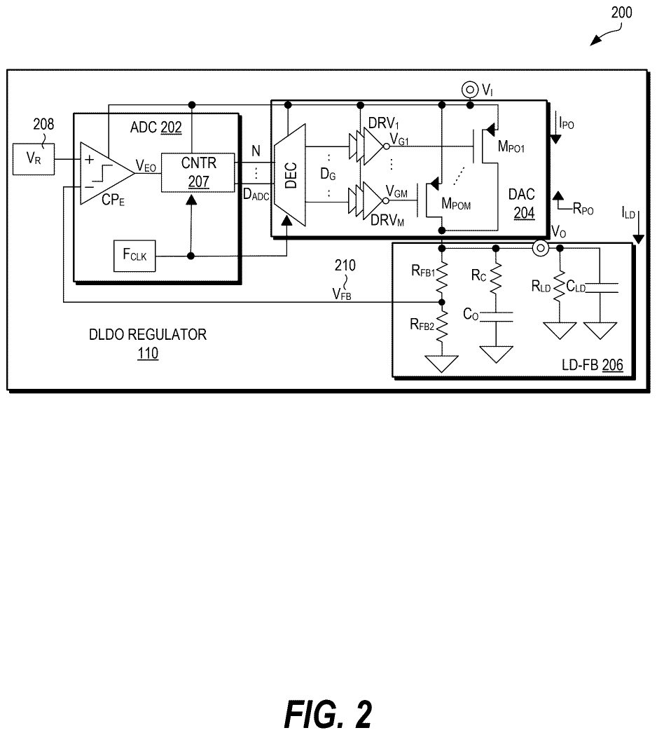

FIG. 2 depicts an architecture 200 for a DLDO regulator 110, as integrated into the SoC 102 depicted in FIG. 1, according to various implementations. The DLDO regulator 110 includes several key functional blocks that collectively enable precise digital control of output voltage (V_{O}), stability, and power supply rejection. The DLDO regulator 110 includes an analog-to-digital converter (ADC) block 202, a digital-to-analog converter (DAC) block 204, and a loaded feedback (LD-FB) block 206.

The ADC block 202 compares a reference voltage (V_{R}) provided by a reference source 208 to a feedback voltage (V_{FB}) carried on a feedback path 210 from the LD-FB block 206, generating an error output voltage (V_{EO}). The ADC 202 includes a comparator (CP_{E}) and a digital counter (CNTR) 207 driven by a clock signal (f_{CLK}). The comparator (CP_{E}) outputs a digital signal based on the polarity of the voltage difference between the reference voltage (V_{R}) and the feedback voltage (V_{FB}), causing the CNTR 207 to increment or decrement a stored digital word (d_{ADC}), typically in binary format. This counter output represents a quantized digital representation of the analog error and serves as an input to the DAC block 204.

The DAC block 204 converts the digital word (d_{ADC}) into an analog current (i_{PO}), adjusting the number of activated power transistor switches (M_{PO1} through M_{POM}). Specifically, the DAC 204 includes a decoder (DEC) that translates the binary digital input (d_{ADC}) into a corresponding thermometer code (d_{G}). This thermometer code controls gate drivers (DRV₁ through DRV_{M}), each of which individually switches an associated pass transistor (e.g., M_{PO1} through M_{POM}) on or off, thus controlling the total pass device current (i_{PO}). Each transistor is typically implemented as a p-channel Metal-Oxide-Semiconductor Field-Effect Transistor (MOSFET) operating in the triode region when active, thereby delivering regulated output voltage (V_{O}) from input voltage (V_{I}).

Each pass transistor in a pass device array may be implemented as a p-channel MOSFET (pMOS) operating in the triode region when active. In some implementations, the pass device array includes equal-sized (linearly weighted) transistor segments to improve DAC linearity and ensure robust performance across process-voltage-temperature (PVT) variations. In other implementations, exponentially weighted (e.g., W/L size in powers of 2) transistor segments may be used for faster response. Linear (equal) weighting can be preferred to avoid DAC non-linearity arising from manufacturing mismatches and transition spikes associated with most-significant-bit (MSB) transitions.

Each individual pMOS pass device, when operating in triode, has an on-resistance (R_{LSB}) that can be a function of the transconductance parameter (K_{P}′), aspect ratio (W/L), the source-gate voltage (V_{SG}), the source-drain (V_{SD}), and the threshold voltage (V_{TP}). By activating one additional parallel power device, the total pass device current (i_{PO}) increases by one LSB value i_{LSB}=V_{SD}/R_{LSB}, where V_{LSB} is t_{SD} source-drain voltage (V_{I}−V_{O}). The effective resistance (R_{PO}) of the combined pass device array decreases as more devices are activated, such that R_{PO} =R_{LSB}/d_{ADC}.

The feedback resistors R_{FB1} and R_{FB2} set a feedback ratio β_{FB} between V_{O} and V_{FB}, enabling the choice of V_{O} to be independent of the typically fixed reference voltage V_{R}. In various implementations, β_{FB}≈V_{R}/V_{O}.

The LD-FB block 206 represents the regulated load and feedback network. The LD-FB block 206 includes an output capacitor (C_{O}) for transient stability and ripple suppression, typically selected to be small enough for full on-chip integration. Associated equivalent series resistance (ESR) (R_{C}) of the output capacitor is also shown, which contributes to the frequency response of the DLDO regulator 110. A load resistor (R_{LD}) and optional load bypass capacitor (C_{LD}) represent the effective impedance of the regulated load. Additionally, the LD-FB block 206 includes feedback resistors (R_{FB1} and R_{FB2}), forming a voltage divider that generates the feedback voltage (V_{FB}) as a scaled version of the regulated output voltage (V_{O}). The feedback voltage (V_{FB}) is returned to the ADC block 202, closing the digital feedback loop.

In operation, when load current (i_{LD}) changes or when fluctuations occur in input voltage (V_{I}), the output voltage (V_{O}) deviates slightly, causing a corresponding change in the feedback voltage (V_{FB}). The ADC block 202 detects this deviation, adjusting the digital counter word (d_{ADC}), subsequently altering the thermometer code (d_{G}), and controlling the number of activated pass devices (M_{PO1} through M_{POM}). As a result, the current i_{PO} adjusts to re-establish the desired regulated output voltage (V_{O}).

This digitally controlled feedback architecture ensures stable, efficient, and responsive regulation of output voltage despite variations in load conditions and input voltage, making it particularly well-suited for integration within densely packed SoC solutions requiring multiple, independently regulated power rails.

In various implementations, a control signal traversing the feedback loop of the DLDO regulator 110 experiences a loop gain (A_{LG}) which can be defined as the product of the gains of the ADC block 202, the DAC block 204, and the LD-FB block 206, denoted as A_{ADC}, A_{DAC}, and Z_{FB}, respectively. The loop gain can be expressed as: A_{LG}=A_{ADC} ×A_{DAC} ×Z_{FB}.

The LD-FB block 206 introduces an output pole (p_{O}) into the feedback loop. The output pole (p_{O}) can be a function of the output resistance (R_{O}) and the output capacitance (C_{O}), where C_{O} and R_{O} form the dominant pole that determines the loop bandwidth. In some implementations, p_{O} can be approximated as: p_{O}≈1/(2π×R_{O}×C_{O}). The output pole p_{O} varies with the pass device resistance (R_{PO}) and, consequently, with the load current (i_{PO}) and the input voltage (V_{I}). This variation can be significant in DLDO regulators because R_{PO} is low and comparable to load resistance R_{LD}, causing the output resistance R_{O} to change substantially across operating conditions.

The ESR (R_{C}) of the output capacitor (C_{O}) can introduce a zero (z_{C}) into the feedback loop at a frequency z_{C} ≈1/(2π×R_{C}×C_{O}). At frequencies near z_{C}, the zero can cancel some of the gain drop and phase delay introduced by the output pole (p_{O}). In some implementations, a bypass load capacitor (C_{LD}) may be intentionally added to reduce transient droop in V_{O} caused by R_{C}, and C_{LD} introduces a load pole (p_{LD}) into the feedback response.

In various implementations, the s-domain (continuous-time) analytical approach is used to model the DLDO feedback loop rather than a z-domain (discrete-time) approach. The s-domain approach can be advantageous because it directly relates to component-level effects from resistors, capacitors, and other circuit elements, and because z-domain analysis may mask effects beyond the clock frequency that arise when the clock is varied in dynamic voltage and frequency scaling (DVFS) applications.

In conventional DLDO regulators, when the feedback voltage (V_{FB}) is close to the reference voltage (V_{R}) at steady state, the comparator output (V_{EO}) can be deterministically 1 in one clock cycle and 0 in the next clock cycle. Specifically, when V_{EO} is 1 (indicating V_{O} is below target), the counter increments d_{ADC} by 1 LSB, turning on one additional pass device and causing V_{O} to overshoot its target slightly. In the next clock cycle, the comparator detects that V_{FB} now exceeds V_{R} and outputs 0, causing the counter to decrement by 1 LSB. This repetitive behavior at the frequency f_{CLK}/2 is known as limit-cycle oscillation and is an inherent consequence of the finite (one-LSB) resolution of the digital feedback loop.

In some implementations, the total phase delay around the feedback loop at f_{CLK}/2 can reach 360°. The counter and sampling poles of the ADC together introduce a 180° phase delay at f_{CLK}/2, which adds with the 180° phase shift from negative feedback (due to an odd number of inversions from the comparator, driver, and pass device), producing a total of 360° loop phase delay. Under this condition, the loop exhibits positive feedback, and the limiting action of the comparator forces the cycle-to-cycle gain to 1, resulting in a sustained oscillation at f_{CLK}/2.

The output voltage ripple Δv_{O} from this limit-cycle oscillation can be approximated as Δv_{O}=(1)×i_{LSB}×R_{O}≈(V_{I}−V_{O})×(R_{PO}∥R_{LD})/R_{LSB}, where R_{O} is the output resistance of the regulator. This represents the minimum achievable output voltage ripple for a conventional DLDO regulator with a given LSB current and output resistance.

In various implementations, the output pole (p_{O}) exhibits considerable variation with load current (i_{LD}) and input voltage (V_{I}). When the delay introduced by p_{O} becomes significant relative to the clock period, the total loop delay (t_{D}) increases beyond the clock period (t_{CLK}), and the positive feedback oscillation condition can be met at a frequency f_{OSC}′ that is less than f_{CLK}/2. This results in sub-clock oscillations in the output voltage (V_{O}).

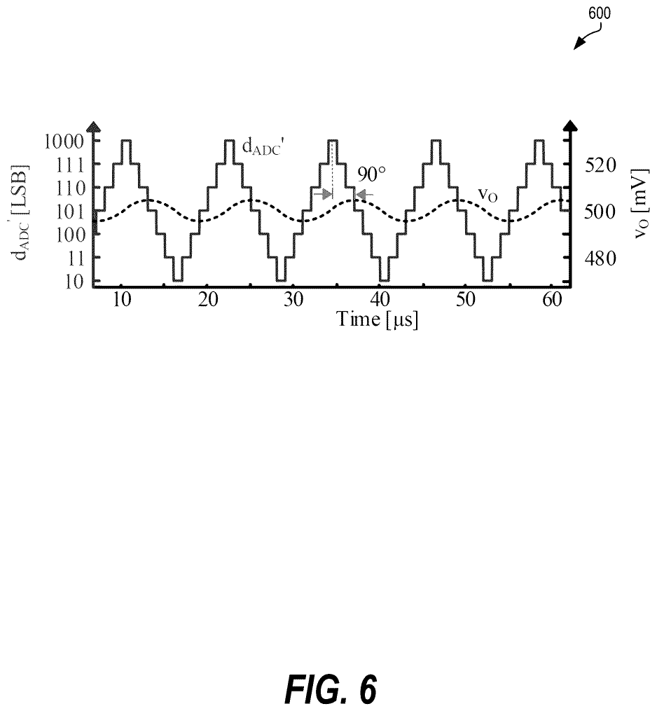

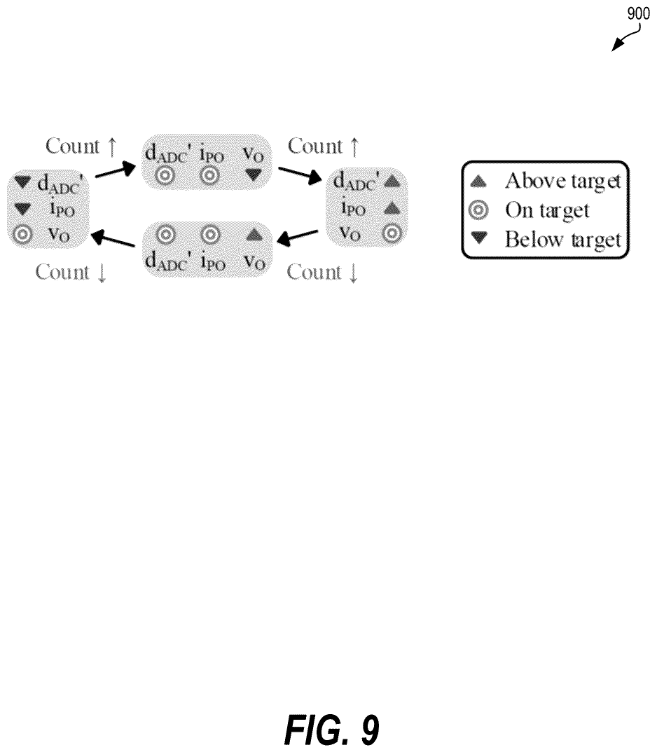

Sub-clock oscillations arise because the output pole delay causes the counter to count beyond the ideal value (d_{ADC(i)}) for a given operating condition. Specifically, when the counter increments toward d_{ADC(i)} and the pass device current (i_{PO}) reaches the optimal load current (i_{LD}), the output voltage (V_{O}) cannot respond within a single clock cycle due to the output pole delay. The comparator continues to perceive V_{FB} as below V_{R} and continues driving the counter to increment beyond d_{ADC(i)}. When the comparator finally detects that V_{FB} has exceeded V_{R} (after the output pole delay has elapsed), the count d_{ADC} is already several LSBs above d_{ADC(i)}. The counter then begins decrementing, but V_{O} continues to rise briefly due to the same pole delay, and the process reverses. This creates an oscillation in which d_{ADC} and V_{O} are approximately 90° out of phase with each other. FIG. 6 depicts a simulated waveform 600 illustrating this sub-clock oscillation behavior, showing the 90° phase relationship between the counter value d_{ADC}′ and the output voltage V_{O}, and FIG. 9 depicts a diagram 900 summarizing the cyclic cause of sub-clock oscillation in terms of the relationships among d_{ADC}′, i_{PO}, and V_{O}.

The sub-clock oscillation period (t_{D}′) can be expressed as t_{D}′==┌t_{PO}/t_{CLK}┐×t_{CLK}, and the counter ripple (Δd_{ADC}′) can be expressed as Δd_{ADC}′=┌t_{PO}/t_{CLK}┐, where ┌ ┐ denotes the ceiling function. This counter ripple translates to an output voltage ripple Δv_{O}′=Δd_{ADC}′×i_{LSB}×R_{PO}≈(V_{I}−V_{O})×(Δd_{ADC}′/d_{ADC}′). The sub-clock oscillations increase in amplitude as the ratio of output pole delay to clock period increases, and can be particularly problematic at low output pole frequencies (corresponding to low load currents or low input voltages).

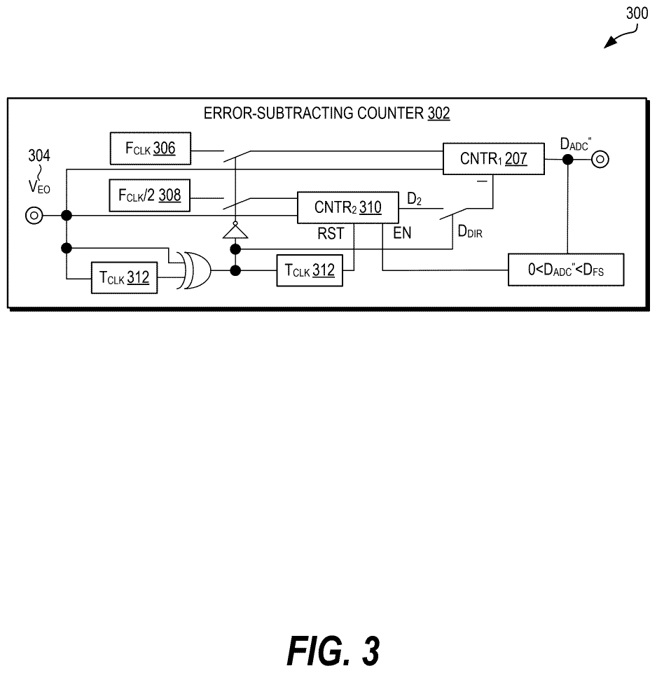

FIG. 3 depicts an error-subtracting counter architecture 300 of an error-subtracting counter circuit 302, corresponding to the digital feedback mechanism of the DLDO regulator 110 introduced herein, according to various implementations. The error-subtracting counter circuit 302 addresses stability challenges, sub-clock oscillations, and transient response limitations encountered by traditional digital LDO architectures.

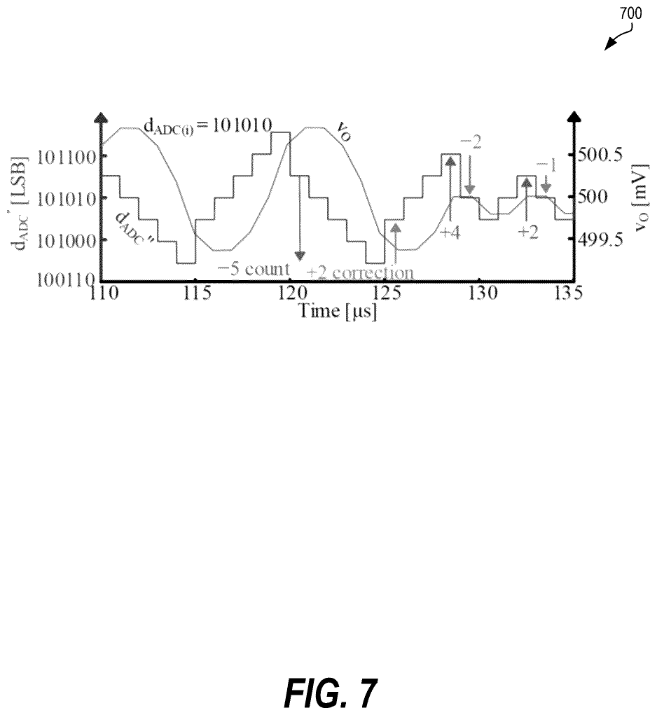

As shown in FIG. 3, the error-subtracting counter circuit 302 receives, as an input, the comparator output (V_{Eo}) signal 304, representing the error condition of the output voltage (V_{O}) relative to the reference voltage (V_{R}). The error condition may be the result of either sudden load current changes or input voltage ripple. This input drives the counters (error accumulating integrators). The main counter, labeled as CNTR₁ 207, is the primary digital counter previously described in FIG. 2 as CNTR 207, storing the digital control word (d_{ADC}″) that directly drives the DAC block 204 to control the output voltage (V_{O}). Additionally, a secondary counter, labeled as CNTR₂ 310 is provided in parallel with the CNTR₁ 207. The counters are driven by two distinct clock signals: a main clock signal (f_{CLK}) 306 and a divided clock signal (f_{CLK}/2) 308. The divided clock signal (f_{CLK}/2) 308 is specifically chosen for the secondary counter, CNTR₂ 310, in order to subtract half the count from the CNTR₁ 207. This is because the CNTR₁ 207 counts twice the amount that is actually needed when an external disturbance from load (i.e., in terms of load current steps), or input (in terms of input voltage ripple) affects the output voltage (V_{O}) (see FIG. 7).

The secondary counter CNTR₂ 310 accumulates digital error corrections at a rate corresponding to the divided clock signal (f_{CLK}/2) 308 and is enabled or reset via control signals depending on the comparator output polarity. Specifically, the secondary counter CNTR₂ 310 is controlled by two logic paths: an enable signal (EN) and a reset signal (RST). The enable signal (EN) is activated conditionally based upon the output of the primary counter CNTR₁ 207, specifically when the primary counter output (d_{ADC}″) is neither zero nor full-scale value (d_{FS}), indicating that further error correction is permissible.

The reset signal (RST) of the secondary counter CNTR₂ 310 is controlled by logic gates, including two delay blocks 312 (each providing a delay equal to the main clock period t_{CLK}) and an exclusive OR (XOR) logic gate. The XOR gate indicates the point at which comparator output changes polarity, which indicates that steady state is achieved. These logic elements generate a reset signal synchronized with the clock signal f_{CLK} 306. The secondary counter CNTR₂ 310 counts intermediate values of digital correction (d₂), which are subtracted from the primary counter CNTR₁ 207 value, thus forming the overall error-subtracting operation.

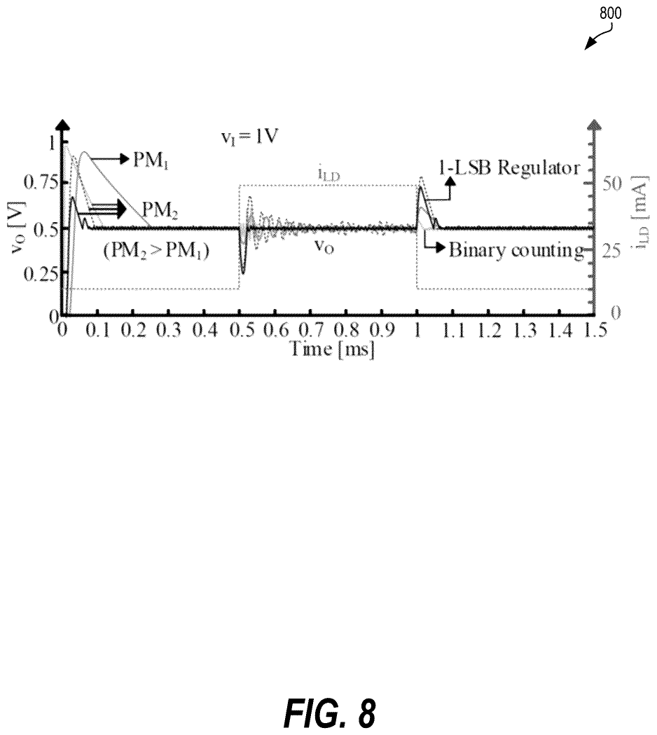

In operation, the secondary counter CNTR₂ 310 rapidly and precisely adjusts the primary counter CNTR₁ 207 output value, proactively removing cumulative errors, reducing or eliminating sub-clock oscillations, and ensuring a faster transient response. Specifically, the error-subtracting counter circuit 302 ensures the output digital control word (d_{ADC}″) remains precisely controlled and stable within desired operating limits, thereby enhancing DLDO regulator stability, responsiveness, power supply rejection, and accuracy. FIGS. 6, 7, and 8 highlight (i) sub-clock oscillation behavior in a conventional DLDO regulator (FIG. 6), (ii) the delay cancellation mechanism of the error-subtracting counter circuit 302 (FIG. 7), and (iii) the transient performance improvement provided by the error-subtracting counter circuit 302 (FIG. 8). Consequently, the error-subtracting counter architecture 300 improves the dynamic performance and robustness of DLDO regulators compared to prior digital control methods, particularly in the context of maintaining stability, suppressing sub-clock oscillations, and enhancing overall PSR performance under varying load and input conditions.

In various implementations, the error-subtracting counter circuit 302 transforms the DLDO regulator 110 into a “one-LSB regulator” in which the oscillation amplitude is enforced at substantially one LSB (Δd_{ADC}″≡1) and the oscillation frequency is restored to approximately f_{CLK}/2. By canceling the effects of the output pole delay, the error-subtracting counter circuit 302 ensures that the counter value d_{ADC}″ closely tracks the ideal operating value d_{ADC(i)} for the current load and input conditions.

The comparator output (V_{EO}) can be characterized as a string of logical ones during a positive half cycle (when V_{O} is below target) and logical zeros during a negative half cycle (when V_{O} is above target). The CNTR₂ 310 (secondary counter), operating at f_{CLK}/2, uses this information to measure the length of the string of ones (or zeros) in V_{EO}. Because the CNTR₂ 310 counts at half the rate of the CNTR₁ 207, the value d₂ accumulated in the CNTR₂ 310 corresponds approximately to the excess count in the CNTR₁ 207 attributable to the output pole delay. This behavior is illustrated in FIG. 7, which depicts the relationship between the counter value (d_{ADC}″) and the output voltage (V_{O}) during error-subtracting counter operation.

For example, during a positive half cycle of the output pole-induced oscillation, the CNTR₁ 207 may count up by four LSBs, of which the first two LSBs bring d_{ADC}″ up to the ideal value (d_{ADC(i)}), while the subsequent two LSBs result from the 90°delay between power device current (i_{PO}) and output voltage (V_{O}) caused by the output pole. These two extra LSBs represent the amplitude (half of four) of the sub-clock oscillation and should be subtracted from the counter to bring d_{ADC}″ back to d_{ADC(i)}. Because the CNTR₂ 310 counts at f_{CLK}/2, its count (d₂) reaches two LSBs during this same period. When d_{ADC}″ changes direction (detected by the XOR gate), d₂ is subtracted from the CNTR₁ 207, setting d_{ADC}″ to its optimal value at the exact point when V_{O} reaches its optimal value. This prevents the output pole delay from sustaining oscillations.

The exclusive-OR (XOR) gate compares V_{EO} values from the current and immediately preceding clock cycles (using the delay blocks 312, each providing one clock-cycle delay t_{CLK}). The XOR gate outputs zero if both its inputs are equal, indicating an excursion from steady state. The XOR gate outputs one when the current and previous V_{EO} states are unequal, indicating that the output voltage V_{O} has reached a limit-cycle peak or trough and is changing direction. This signal, denoted d_{DIR}, triggers the oscillation cancellation by initiating the subtraction of d₂ from the CNTR₁ 207 and subsequently resetting the CNTR₂ 310 to zero at the next clock cycle to prepare for the next oscillation occurrence.

In various implementations, counting on both the CNTR₁ 207 and the CNTR₂ 310 can be disabled during the clock cycle in which the subtraction occurs. This prevents metastability errors that could arise from simultaneously writing to and reading from the counters. In some implementations, this is achieved by gating the clock or enable signals to both counters during the subtraction cycle.

In certain operating conditions, such as startup (when d_{ADC}″ is recovering from zero) or railing out (when d_{ADC}″ has reached the full-scale value d_{FS}), the parallel count (d₂) may not correspond to half the oscillation amplitude because the CNTR₂ 310 has not stopped counting in parallel with the CNTR₁ 207 at the appropriate time. To address this, the error-subtracting counter circuit 302 can include logic (represented in FIG. 3 by the enable path controlled by the condition 0<d_{ADC}″<d_{FS}) that disables the CNTR₂ 310 under these conditions. In some implementations, this functionality is realized with a flip-flop that clears when d_{ADC}″ equals zero or d_{FS} and sets when the d_{DIR} signal goes high (upon reaching steady state). When the CNTR₂ 310 is disabled, the DLDO regulator 110 may operate with faster startup and recovery but may exhibit some transient ringing until steady-state one-LSB regulation resumes.

In some implementations, the CNTR₁ 207 (primary counter) may employ a binary counting scheme in which the change in count doubles every clock cycle rather than incrementing or decrementing by a fixed value of one. This can provide substantially faster transient response because the count reaches the ideal operating value in exponentially faster time relative to the array unit size, rather than linear time. This effect is seen in FIG. 8, on the plot marked “binary counting.”

In such implementations, the CNTR₂ 310 (error-subtracting counter) can also be adapted to operate with the binary counting scheme. Because the change in the count held by the CNTR₁ 207 now doubles every clock cycle, the CNTR₂ 310 (also doubling at f_{CLK}/2) must return the count to the value corresponding to half the oscillation time, rather than subtracting half the final value. For example, if the parallel count (d₂) is 32 when the XOR output (d_{DIR}) goes high, and the count value at half the time was 4, the value to be subtracted is 32−4=28. In some implementations, two parallel counters may be employed, with one operating at f_{CLK} for the subtraction and another at f_{CLK}/2 for accumulation, to achieve this time-based correction. In these implementations, only the counters use exponential weighting; the power device array can maintain linear (equal) weighting to preserve DAC linearity for steady-state accuracy.

Alternatively, other counting schemes may be used, such as exponential counting with a power less than 2, recursive Fibonacci series counting, or interval search, each providing different tradeoffs between response speed and output ripple.

In various implementations, the error-subtracting counter circuit 302 can improve the power supply rejection (PSR) of the DLDO regulator 110, particularly at lower frequencies. In a conventional DLDO regulator, the power device (M_{PO}) operates as a switch, and the pass device resistance (R_{PO}) forms a resistive divider with the loaded feedback resistance (R_{LD}∥R_{FB}). Because R_{PO} in triode can be quite small, a portion of the input voltage V_{I} ripple can pass through to the output voltage V_{O}, resulting in low PSR.

Sub-clock oscillations in conventional DLDO regulators can further degrade PSR by extending loop delay and increasing supply gain through positive feedback. The one-LSB regulator configuration provided by the error-subtracting counter circuit 302 extends negative feedback to higher operating frequencies and can cancel ripple or disturbances injected from the input to the output at frequencies lower than f_{CLK}/2. In various implementations, input voltage ripple injected from input to output can be removed after a half-cycle, improving PSR performance.

In some implementations, the PSR improvement provided by the error-subtracting counter circuit 302 applies in a small-signal context. Specifically, to maintain one-LSB regulation under input voltage variations, the maximum slope of the input voltage V_{I}(∂V_{I}/∂t) should not exceed the maximum slew rate of the DLDO regulator, which can be approximated as Δv_{O}×f_{CLK}, where Δv_{O} is the one-LSB output voltage ripple. If the input voltage is expected to have slewing exceeding this rate, the clock frequency (f_{CLK}) may need to be increased, or the DLDO regulator may not provide adequate PSR for that application.

In various implementations, additional design techniques can be applied to enhance the stability and performance of the DLDO regulator 110. For example, a bypass capacitor may be added across the first feedback resistor R_{FB1} to introduce an in-phase zero into the feedback loop, preserving gain and phase that might otherwise be lost to the output pole. In some implementations, a feed-forward capacitor may bypass the DAC block 204 to create a similar in-phase zero effect. An in-phase zero may also be created within the ADC block 202 in the digital domain to achieve a similar effect.

In implementations supporting DVFS, the clock of the load can directly drive (or a fractional frequency derivative of it can be used with) the DLDO regulator 110 when operating in DVFS mode. This can eliminate the need for a separate clock source for the DLDO regulator and can reduce power loss. The power loss (P_{LOSS}) of the DLDO regulator 110 can be approximated as P_{LOSS}≈i_{Q}×V_{I}+f_{CLK}×C_{G(EQ)}×V_{I}², where i_{Q} is the quiescent current used by the DLDO feedback control and C_{G(EQ)} is the equivalent capacitance presented by the DLDO to the input. Further loss reduction may be obtained by clock-gating inactive sections of the counter and decoder.

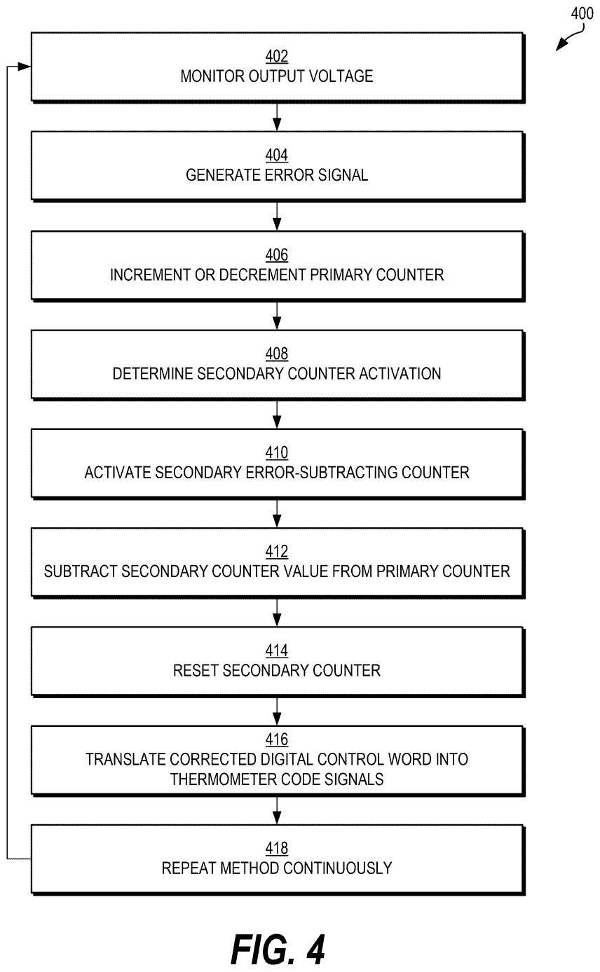

FIG. 4 depicts a method 400 for operating the DLDO regulator 110, according to various implementations. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 400 begins and proceeds to block 402. At block 402, the loaded feedback block (LD-FB) 206 of the DLDO regulator 110 monitors the regulated output voltage (V_{O}), using a feedback resistor divider including the feedback resistors (R_{FB1} and R_{FB2}), thereby generating a scaled feedback voltage (V_{FB}) indicative of the regulator output relative to a desired voltage reference (V_{R}). At block 404, the analog-to-digital converter (ADC) block 202 uses comparator (CP_{E}) to compare the feedback voltage (V_{FB}) to the predetermined reference voltage (VR) provided by the reference source 208, generating a digital error signal (V_{EO}) indicating whether the output voltage (V_{O}) is above or below the desired target.

At block 406, the primary counter CNTR₁ 207 increments or decrements its stored digital word (d_{ADC}″) based on the digital error signal (V_{EO}), adjusting the digital representation used for controlling the number of active transistor segments (M_{PO1} through M_{POM}) within the DAC block 204. At block 408, logic circuitry evaluates whether the primary digital control word (d_{ADC}″) is within an allowable operational range (greater than zero and less than the full-scale digital word (d_{FS}); if so, the logic circuitry enables the operation of a secondary counter, the error-subtracting counter 310 (CNTR₂), to perform error subtraction. Otherwise, the logic circuitry maintains the current setting of the primary counter 207 without activating error subtraction.

At block 410, the error-subtracting counter 310 (CNTR₂) accumulates intermediate digital error corrections at a fraction of the frequency of the primary clock frequency 306 (f_{CLK}), typically half this frequency (f_{CLK}/2), shown as frequency divider 308). At block 412, digital subtraction circuitry subtracts the accumulated intermediate digital value (d₂) stored in the error-subtracting counter 310 (CNTR₂) from the primary counter digital word (d_{ADC}″), resulting in an updated, corrected digital control word for precise regulation. At block 414, reset circuitry including delay blocks 312 and logic gates (such as an XOR gate) resets the error-subtracting counter 310 (CNTR₂) in synchronization with the primary clock signal 306 (f_{CLK}), thereby preventing counter saturation and enabling continuous real-time error tracking.

At block 416, the decoder logic (DEC in FIG. 2) translates the corrected digital control word into thermometer code (d_{G}) signals that selectively activate or deactivate transistor gate drivers (DRV₁ through DRV_{M}), controlling transistor segments (M_{PO1} through M_{POM}) in the DAC block 204. This selective activation regulates the output current (i_{PO}), adjusting and stabilizing the output voltage (V_{O}). At block 418, the DLDO regulator 110 may continuously repeat blocks 402 through 416 during normal operation, dynamically maintaining accurate, stable, low-ripple voltage output despite variations in input voltage (V_{I}) and load current (i_{LD}).

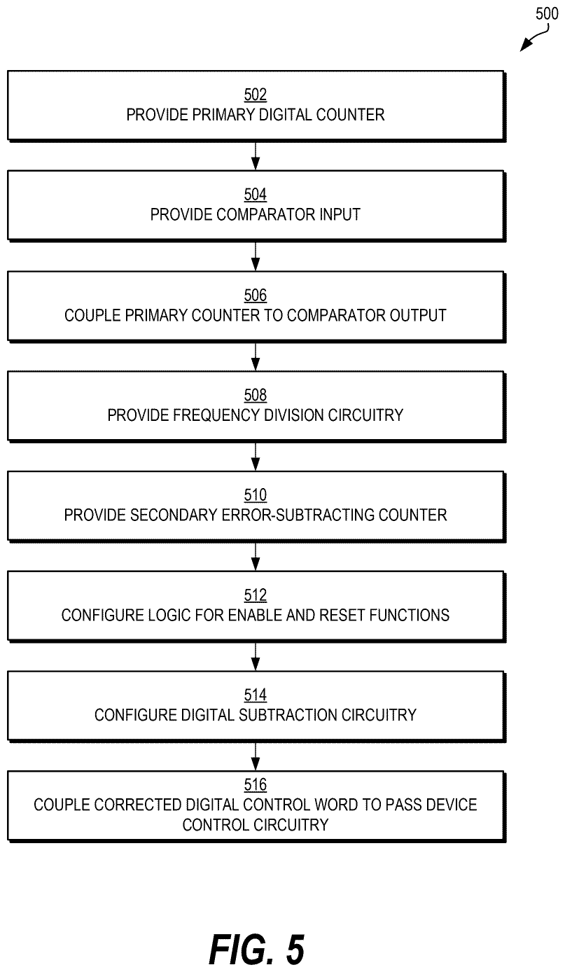

FIG. 5 depicts a method 500 for fabricating and configuring the error-subtracting counter 310 within the DLDO regulator 110, according to various implementations. The method 500 begins and proceeds to block 502. At block 502, semiconductor fabrication processes or digital logic integration techniques provide a primary digital counter 207 (CNTR₁), configured to store and update a digital control word (d_{ADC}″), which directly controls pass transistor segments (M_{PO1} through M_{POM}) within the DAC Block 204 of the DLDO regulator 110.

At block 504, comparator circuitry (such as comparator CP_{E} within the ADC block 202) is provided to generate a digital error signal (V_{EO}) based on the voltage difference between the feedback voltage (V_{FB}) (from the LD-FB block 206) and a stable reference voltage (V_{R}) (from reference source 208).

At block 506, coupling circuitry connects the primary digital counter 207 (CNTR₁) directly to the comparator output (V_{EO}), enabling the primary digital counter 207 (CNTR₁) to increment or decrement its stored digital value (d_{ADC}″) based on the comparator output. At block 508, frequency division circuitry including frequency divider 308 (f_{CLK}/2) provides a secondary clock signal at half the frequency of the primary clock 306 (f_{CLK}) , used for timing the operation of the error-subtracting counter 310 (CNTR₂).

At block 510, semiconductor processes or logic integration methods provide and configure the error-subtracting counter 310 (CNTR₂) to accumulate intermediate digital error values (d₂) at the reduced frequency (f_{CLK}/2), preparing for subsequent error subtraction operations. At block 512, logic circuitry including delay blocks 312 and XOR gates is configured to generate reset signals (RST) and conditional enable signals (EN), controlling the reset and operational enablement of the error-subtracting counter 310 (CNTR₂), based on predetermined conditions related to the range of the digital control word (d_{ADC}″).

At block 514, digital subtraction circuitry is configured to subtract the intermediate accumulated digital value (d₂) from the error-subtracting counter 310 (CNTR₂) from the primary digital control word (d_{ADC}″), generating a final corrected digital control word. At block 516, coupling circuitry connects the corrected digital control word from the subtraction circuitry to decoder logic (e.g., DEC within the DAC block 204), enabling precise and accurate control over the gate drivers (DRV₁ through DRV_{M}) and associated transistor segments (M_{PO1} through M_{POM}) to provide stable and regulated output voltage (V_{O}).

FIG. 6 depicts a simulated waveform 600 illustrating sub-clock oscillation behavior in a conventional DLDO regulator without the error-subtracting counter circuit 302, according to various implementations. FIG. 6 plots the digital control word (d_{ADC}′, shown in LSB on the left vertical axis) and the output voltage (V_{O}, shown in millivolts on the right vertical axis) as functions of time (in microseconds on the horizontal axis). As depicted in FIG. 6, the digital control word (d_{ADC}′) oscillates over a range of several LSBs (e.g., between approximately binary “10” and binary “1000” in the example shown), and the output voltage V_{O} oscillates correspondingly around a target value of approximately 500 mV. The 90° phase offset between d_{ADC}′ and V_{O} is annotated in FIG. 6, illustrating the delay introduced by the output pole (p_{O}) as described above. The oscillation period is greater than the clock period (t_{CLK}), confirming that the oscillation frequency is below f_{CLK}/2 and thus constitutes a sub-clock oscillation. This sub-clock oscillation results in undesirable output voltage ripple that degrades the quality of the regulated supply voltage.

FIG. 7 depicts a simulated waveform 700 illustrating delay cancellation by the error-subtracting counter circuit 302, according to various implementations. FIG. 7 plots the digital control word (d_{ADC}″, shown in LSB on the left vertical axis) and the output voltage (V_{O}, shown in millivolts on the right vertical axis) as functions of time (in microseconds on the horizontal axis). The ideal operating value d_{ADC(i)} is annotated at the top of FIG. 7 (e.g., binary 101010 in the example shown). As depicted in FIG. 7, during a first oscillation half-cycle, the CNTR₁ 207 counts up by several LSBs beyond d_{ADC(i)} due to the output pole delay (e.g., +4 LSBs in the annotated example). The error-subtracting counter circuit 302 then applies a correction (e.g., −2 LSBs, as annotated) when the d_{DIR} signal indicates a change in direction, reducing the count to approximately d_{ADC(i)} as described above. This subtraction is followed by a count decrement (e.g., −5 count, as annotated) and a subsequent upward correction (e.g., +2 correction). As a result, subsequent oscillation cycles are reduced in amplitude, with the waveform 700 showing the output voltage V_{O} converging toward a stable value (e.g., approximately 500 mV) with substantially reduced ripple (e.g., on the order of 0.5 mV) compared to the sub-clock oscillation depicted in FIG. 6.

FIG. 8 depicts a simulated load dump response 800 comparing transient performance of conventional DLDO regulators with a DLDO regulator employing the error-subtracting counter circuit 302, according to various implementations. FIG. 8 plots the output voltage (V_{O}, shown in volts on the left vertical axis) and the load current (i_{LD}, shown in milliamps on the right vertical axis) as functions of time (in milliseconds on the horizontal axis), with an input voltage V_{I} of 1 V. A load current step (e.g., from approximately 1 mA to 50 mA and back) is applied as depicted by the i_{LD} waveform. Two conventional DLDO regulator responses are shown, corresponding to different phase margins: a first response with a lower phase margin PM₁ exhibiting sustained ringing after the load step due to low output pole frequency, and a second response with a higher phase margin PM₂ (where PM₂>PM₁) exhibiting a more pronounced initial undershoot but less sustained ringing. The response of the DLDO regulator employing the error-subtracting counter circuit 302 is depicted as the “1-LSB Regulator” response, which exhibits reduced undershoot and substantially no ringing upon recovery. FIG. 8 also depicts a “Binary counting” response corresponding to implementations in which the CNTR₁ 207 employs the binary counting scheme described above, demonstrating faster transient recovery. This comparison illustrates the improvement in transient stability provided by the error-subtracting counter circuit 302.

FIG. 9 depicts a diagram 900 illustrating the cause of sub-clock oscillation in a conventional DLDO regulator, according to various implementations. The diagram 900 depicts the cyclical relationships among the digital control word (d_{ADC}′), the pass device current (i_{PO}), and the output voltage (V_{O}) during sub-clock oscillation. Each state in the cycle is characterized by whether d_{ADC}′, i_{PO}, and V_{O} are above target, on target, or below target. As depicted in FIG. 9, when the counter is incrementing, d_{ADC}′ and i_{PO} may be below target while V_{O} is on target, indicating the beginning of an upward count excursion. Due to the output pole delay described above, by the time the counter reverses direction, d_{ADC}′ has risen above target while V_{O} has just recovered. The cycle continues as the counter decrements and the same delay causes d_{ADC}′ to undershoot the ideal value before V_{O} can respond. This cyclic behavior, driven by the phase delay between d_{ADC}′ and V_{O}, sustains the sub-clock oscillation depicted in FIG. 6.

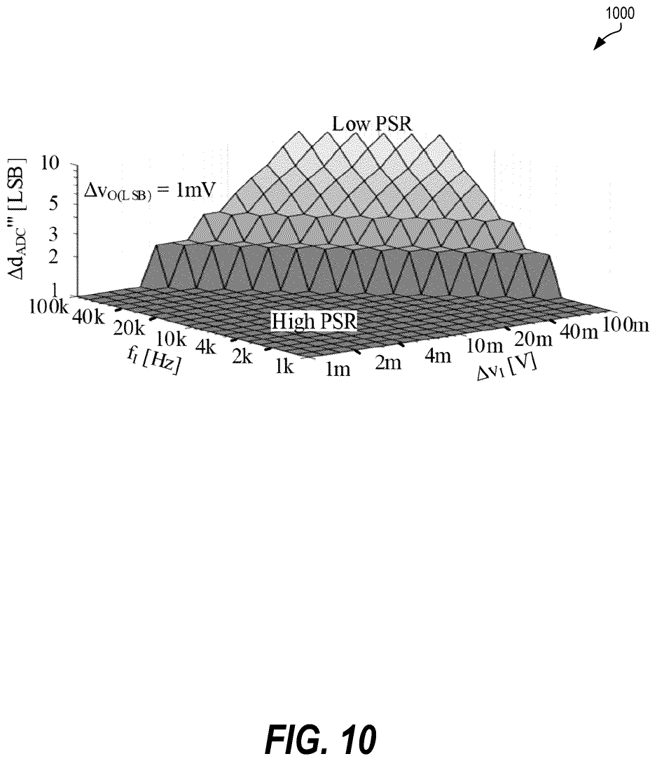

FIG. 10 depicts a graph 1000 illustrating simulated slew rate thresholds for power supply rejection in the DLDO regulator 110 employing the error-subtracting counter circuit 302, according to various implementations. FIG. 10 is a three-dimensional surface plot with the input voltage ripple frequency (f_{I}, shown in hertz on a first horizontal axis), the input voltage ripple amplitude (Δv_{I}, shown in volts on a second horizontal axis), and the resulting count residue ripple (Δd_{ADC}′″, shown in LSBs on the vertical axis). A one-LSB output voltage ripple Δv_{O(LSB)} of 1 mV is indicated in the example shown. The surface plot indicates that at lower input ripple frequencies and smaller input ripple amplitudes, the count residue Δd_{ADC}″′ remains at or near one LSB, corresponding to a region of high PSR in which the error-subtracting counter circuit 302 maintains one-LSB regulation. As the input ripple frequency and amplitude increase, Δ_{ADC}″′ increases beyond one LSB, corresponding to a region of low PSR in which the input voltage slew rate exceeds the maximum correction rate of the DLDO regulator (approximately Δv_{O}×f_{CLK}). The transition between the high PSR and low PSR regions represents the slew rate threshold described above, indicating the operating boundary within which the error-subtracting counter circuit 302 can maintain effective power supply rejection.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The features, structures, or characteristics described above may be combined in one or more implementations in any suitable manner, and the features discussed in the various implementations are interchangeable, if possible. In the following description, numerous specific details are provided in order to fully understand the implementations of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

Therefore, the following is claimed:

1. A digital low-dropout (DLDO) voltage regulator, comprising:
a comparator configured to compare a feedback voltage derived from a regulated output voltage with a reference voltage and to generate a digital error signal based on the comparison;
a primary digital counter coupled to the comparator and configured to increment or decrement a digital control word based on the digital error signal;
a secondary digital counter coupled to the comparator and clocked at half a clock frequency of the primary digital counter, the secondary digital counter configured to accumulate an intermediate digital value based on the digital error signal;
one or more delay elements and an exclusive-OR gate coupled to the comparator, the exclusive-OR gate configured to generate a direction-change signal indicating a change in polarity of the digital error signal between successive clock cycles;
subtraction circuitry configured to subtract the intermediate digital value from the digital control word to produce a corrected digital control word in response to the direction-change signal;
enable logic configured to enable the secondary digital counter when the digital control word is greater than zero and less than a full-scale maximum value, and to disable the secondary digital counter otherwise; and
a pass device array comprising a plurality of transistor segments, the pass device array configured to receive a control signal derived from the corrected digital control word and to regulate the output voltage based on the control signal.

2. The DLDO voltage regulator of claim 1, further comprising a decoder configured to convert the corrected digital control word into a thermometer code, and a plurality of gate drivers configured to selectively activate transistor segments in the pass device array based on the thermometer code.

3. The DLDO voltage regulator of claim 1, wherein each transistor segment of the pass device array comprises a p-channel Metal-Oxide-Semiconductor Field-Effect Transistor (MOSFET) operating in a triode region when active, and wherein the transistor segments are linearly weighted such that each transistor segment has a substantially equal channel width-to-length ratio.

4. The DLDO voltage regulator of claim 1, wherein the enable logic comprises a flip-flop configured to clear when the digital control word equals zero or the full-scale maximum value and to set when the direction-change signal is asserted.

5. The DLDO voltage regulator of claim 1, wherein the primary digital counter is configured to employ a binary counting scheme in which a change in the digital control word doubles with each successive clock cycle.

6. The DLDO voltage regulator of claim 1, wherein counting by the primary digital counter and the secondary digital counter is disabled during a clock cycle in which the subtraction circuitry subtracts the intermediate digital value from the digital control word.

7. A method for regulating an output voltage in a digital low-dropout (DLDO) voltage regulator, the method comprising:
comparing a feedback voltage derived from the output voltage with a reference voltage to generate a digital error signal;
updating a digital control word stored in a primary digital counter by incrementing or decrementing the digital control word based on the digital error signal;
accumulating an intermediate digital value in a secondary digital counter at half a clock frequency of the primary digital counter based on the digital error signal;
detecting a change in polarity of the digital error signal between successive clock cycles;
in response to detecting the change in polarity, subtracting the intermediate digital value from the digital control word to produce a corrected digital control word; and
controlling a pass device array based on the corrected digital control word to regulate the output voltage.

8. The method of claim 7, further comprising:
enabling the secondary digital counter when the digital control word is greater than zero and less than a full-scale maximum value; and
disabling the secondary digital counter when the digital control word equals zero or the full-scale maximum value.

9. The method of claim 7, further comprising resetting the secondary digital counter after subtracting the intermediate digital value from the digital control word.

10. The method of claim 7, further comprising disabling counting by the primary digital counter and the secondary digital counter during a clock cycle in which the subtracting occurs.

11. The method of claim 7, wherein detecting the change in polarity comprises comparing a current value of the digital error signal to a previous value of the digital error signal using an exclusive-OR gate.

12. The method of claim 7, wherein controlling the pass device array comprises decoding the corrected digital control word into a thermometer code and driving a plurality of pass transistors based on the thermometer code.

13. The method of claim 7, wherein updating the digital control word comprises doubling a magnitude of a change in the digital control word with each successive clock cycle.

14. A voltage regulator circuit, comprising:
a first counter configured to store a control word and to update the control word based on a comparison between a feedback signal and a reference signal;
a second counter clocked at a fraction of a clock frequency of the first counter, the second counter configured to accumulate a correction value based on the comparison;
a polarity-change detector coupled to an output of the comparison, the polarity-change detector configured to generate a trigger signal upon detecting a change in polarity of the output of the comparison; and
subtraction circuitry configured to subtract the correction value from the control word in response to the trigger signal to produce a corrected control word for controlling an output voltage of the voltage regulator circuit.

15. The voltage regulator circuit of claim 14, wherein the second counter is clocked at half the clock frequency of the first counter.

16. The voltage regulator circuit of claim 14, wherein the polarity-change detector comprises one or more delay elements and a logic gate.

17. The voltage regulator circuit of claim 14, further comprising enable circuitry configured to enable the second counter when the control word is within an operational range and to disable the second counter when the control word is outside the operational range.

18. The voltage regulator circuit of claim 17, wherein the operational range excludes a minimum value and a maximum value of the control word.

19. The voltage regulator circuit of claim 14, further comprising a pass device array comprising a plurality of transistor segments, the pass device array configured to regulate the output voltage based on the corrected control word.

20. The voltage regulator circuit of claim 14, wherein the subtraction circuitry is further configured to reset the second counter after subtracting the correction value from the control word.
